(19) United States
(12) Patent Application Publication
(10) Pub. No.: US 2012/0259706 A1
(43) Pub. Date: Oct. 11, 2012

(54) VEHICLE NAVIGATION SYSTEM AND METHOD

(75) Inventors: Anthony G. LOBAZA, Bloomfield Hills, MI (US); Michael J. QUINN, Troy, MI (US); Richard C. VANITVELT, Metamora, MI (US)

(73) Assignee: GM GLOBAL TECHNOLOGY OPERATIONS LLC, DETROIT, MI (US)

(21) Appl. No.: 13/080,526

(22) Filed: Apr. 5, 2011

(51) Int. Cl. G06Q 30/00; G01C 21/00

(52) U.S. Cl. 705/14.62; 705/14.66; 705/14.64

(57) ABSTRACT

Methods and systems are provided for a vehicle. An occupant of the vehicle is identified. Information pertaining to the occupant is accessed from a database. Marketing material is provided to the occupant based on the information.

### TECHNICAL FIELD

The present disclosure generally relates to the field of vehicles and, more specifically, to methods and systems for use in conjunction with vehicle navigation systems.

### BACKGROUND

The present disclosure generally relates to the field of vehicles and, more specifically, to methods and systems for use in conjunction with vehicle navigation systems.

Many vehicles today include vehicle navigation systems that provide information to the occupants of the vehicle as to a location of the vehicle. Often, the navigation systems also provide lists including various points of interest or locations. For example, such lists often include lists of nearby restaurants, service stations, hotels, retail stores, or other locations.

However, the full potential of vehicle navigation systems has yet to be realized. For example, existing vehicle navigation systems may not provide as much information as would be optimal under various circumstances. In addition, existing vehicle navigation systems may not provide information to the occupants of the vehicle in a manner that is tailored to the occupants with an optimal amount of specificity under certain circumstances.

Accordingly, it is desirable to provide improved navigation systems for vehicle. It is also desirable to provide improved methods for utilizing vehicle navigation systems. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a method for marketing to an occupant of a vehicle is provided. The method comprises the steps of identifying the occupant, accessing information pertaining to the occupant from a database, and providing marketing material to the occupant based on the information.

In accordance with another exemplary embodiment, a method of notifying an occupant of a vehicle travelling toward a destination is provided. The method comprises the steps of accessing a calendar of the occupant, determining a desired time for the driver to reach the destination using the calendar, and providing a notification to the driver regarding a desired route for the vehicle based on the desired time.

In accordance with a further exemplary embodiment, a system for marketing to an occupant of a vehicle is provided. The system comprises a processor and a delivery unit. The processor is configured to identify the occupant, access information pertaining to the occupant from a database, and provide instructions for delivery of marketing material to the occupant based on the information. The delivery unit is coupled to the processor, and is configured to deliver the marketing material to the occupant based on the instructions.

### BRIEF DESCRIPTION OF THE DRAWINGS

Certain embodiments of the present disclosure will hereinafter be described in conjunction with the following drawing figures, wherein like numerals denote like elements, and wherein:

FIG. 1 is a functional block diagram of a navigation system for a vehicle, in accordance with an exemplary embodiment; and

FIG. 2 is a flowchart of a process for providing information to occupants of the vehicle, and that can be implemented in connection with the navigation system of FIG. 1, in accordance with an exemplary embodiment.

### DETAILED DESCRIPTION

The following detailed description is merely exemplary in nature, and is not intended to limit the disclosure or the application and uses thereof. Furthermore, there is no intention to be bound by any expressed or implied theory presented in the preceding technical field, background, or the following detailed description.

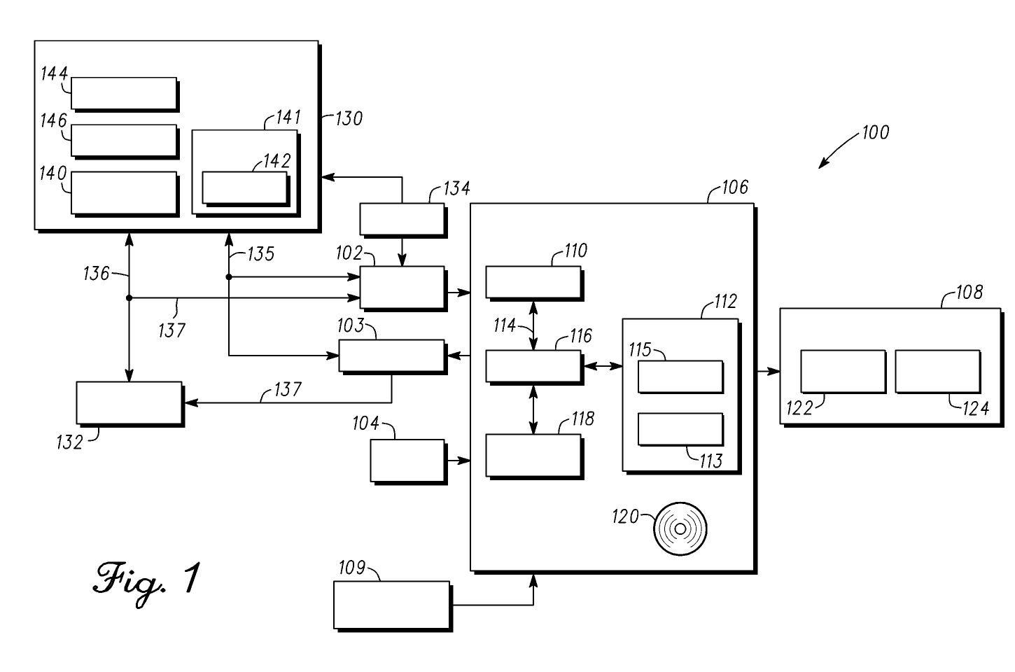

FIG. 1 is a functional block diagram of a navigation system 100 for a vehicle. The navigation system 100 provides various information and materials to occupants of the vehicle, including marketing material targeted to the occupants, information regarding recommended routes to a destination, and an optimized display and notification regarding various points of interest near the vehicle. As used throughout this application, a point of interest refers to any location (e.g., hotels, restaurants, retail stores, service stations, and/or other locations) that may be of interest to the occupants of a vehicle. In certain embodiments, the navigation system 100 is used in conjunction with an automobile, such as a sedan, a truck, a van, a sport utility vehicle, or another type of automobile. In various other embodiments, the navigation system 100 is used in connection with one or more other types of vehicles.

As depicted in FIG. 1, the navigation system 100 includes a receiver 102, a transmitter 103, an input device 104, a computer system 106, and a display and notification unit 108. The navigation system 100 is preferably disposed onboard the vehicle. Also as depicted in FIG. 1, the navigation system 100 is preferably configured to interface directly or indirectly with a remote server 130, a user wireless device 132 of a vehicle occupant (such as a cellular telephone and/or Bluetooth device), and a user computer 134 of the vehicle occupant.

The receiver 102 is configured to receive signals and/or information pertaining to the occupant, the vehicle, and various points of interest (POI) that may be near the vehicle and/or a path of the vehicle. In one example, the receiver 102 receives signals via a wireless connection 137 (such as a Bluetooth or other short range wireless connection) from the user wireless device 132 that may be utilized in identifying one or more occupants of the vehicle. The receiver 102 also receives signals and information regarding a current geographic position or location of the vehicle from one or more satellites or as part of a global positioning system (GPS). In certain exemplary embodiments, the receiver 102 also receives signals and information regarding locations of the points of interest and/or user history regarding prior visits to the points of interest and/or preferences regarding the points of interest. In addition, the receiver 102 preferably also receives information via the remote server 130, the user wireless device 132, and the user computer 134 for use by the navigation system 100 in providing targeted marketing material and other information for the occupant of the vehicle. The receiver 102 provides the signals and/or information to the computer system 106 for processing, and ultimately for use in providing marketing material and other information to the occupants of the vehicle.

The transmitter 103 is configured to transmit marketing information as well as signals and/or information pertaining to the vehicle and various points of interest (POI) that may be near the vehicle and/or a path of the vehicle. In one embodiment, the transmitter 103 transmits marketing material (such as an advertisement, a menu, a coupon, and/or one or more other types of marketing material pertaining to one or more nearby points of interest) to the user wireless device 132 via wireless connection 137 (such as a Bluetooth or other short range wireless connection). Also in an exemplary embodiment, the transmitter 103 transmits signals and information regarding a current geographic position or location of the vehicle to the remote server 130. In addition, the transmitter 103 may also transmit signals and information regarding locations of the points of interest and/or user history regarding prior visits to the points of interest and/or preferences regarding the points of interest to the remote server 130.

The input device 104 is configured to obtain inputs from a user, preferably from one or more occupants of the vehicle. The occupant may use the input device 104 to identify the name of the occupant, for example in situations in which the driver and/or other occupants of the vehicle may vary. The occupant may also use the input device 104 to request that the navigation system 100 display certain types of information, such as specific types of points of interest and/or certain types of marketing materials in which the user may be interested. In addition, the user may use the input device 104 to provide various information regarding specific points of interest, such as preferences or ratings of the user pertaining to specific points of interest. By way of example only, the input device 104 may include one or more buttons, switches, rotary knobs, touch screens, touch panels, capacity panels, swipe operations, and/or one or more other types of devices.

The computer system 106 is coupled between the receiver 102, the transmitter 103, the input device 104, the other vehicle systems 109, and the display and notification unit 108. The computer system 106 receives the above-described signals, information, and user inputs from the receiver 102, the transmitter 103, and the input device 104. In certain embodiments, the computer system 106 may also be coupled (for example, via a communications bus or network) to receive information from or regarding various other vehicle systems 109. The computer system 106 processes the various signals, information, and user inputs and provides instructions for the display and notification unit 108 and/or the transmitter 103 to provide marketing material and other information to the occupants of the vehicle. In addition, in certain embodiments, the computer system 106 also provides instructions for the transmission of signals and information by the transmitter 103 to the remote server 130 for remote, off-board storage or processing, and may also receive information and/or instructions from the remote server 130 via the receiver 102.

As depicted in FIG. 1, the computer system 106 includes a processor 110, a memory 112, a computer bus 114, an interface 116, and a storage device 118. The processor 110 performs the computation and control functions of the computer system 106 or portions thereof, and may comprise any type of processor or multiple processors, single integrated circuits such as a microprocessor, or any suitable number of integrated circuit devices and/or circuit boards working in cooperation to accomplish the functions of a processing unit. During operation, the processor 110 executes one or more programs 113 preferably stored within the memory 112 and, as such, controls the general operation of the computer system 106.

The processor 110 receives the above-referenced signals, information, and user inputs from the receiver 102, the input device 104, and the other vehicle systems 109. The processor 110 processes the signals, information, and user inputs and provides instructions to the display and notification unit 108 and/or the transmitter 103 to provide marketing material and other information to the occupants of the vehicle. In addition, in certain embodiments, the processor 110 also provides instructions for the transmission of signals and information by the transmitter 103 to the remote server 130 for remote storage or processing.

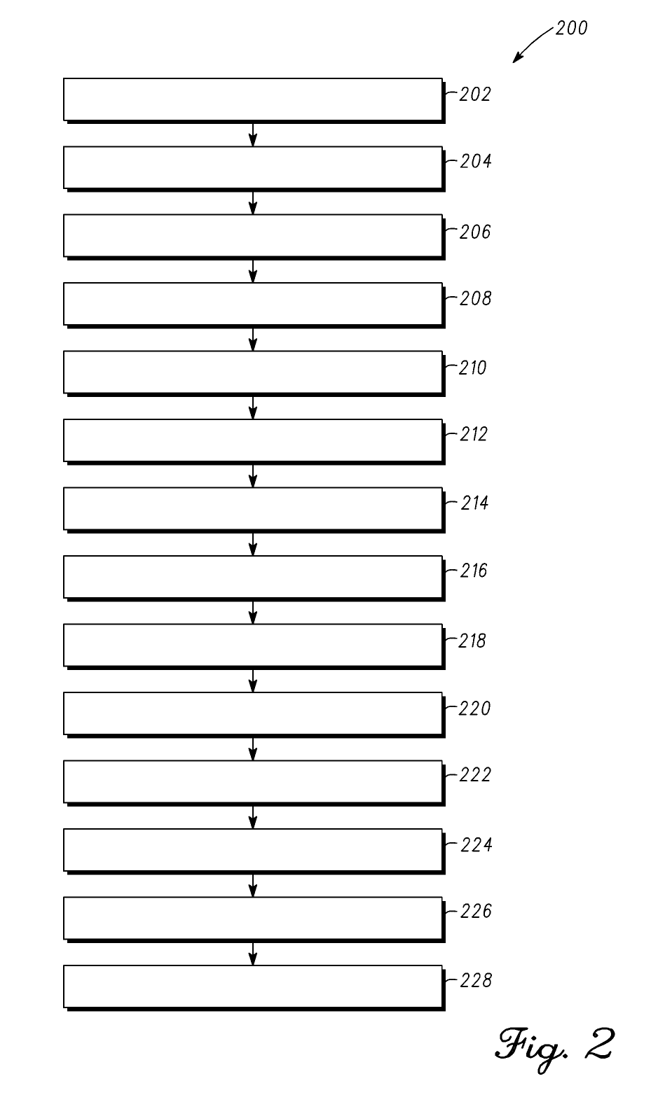

The processor 110 preferably performs these functions in accordance with the steps of the process 200 depicted in FIG. 2 and described further below in connection therewith. In addition, in one exemplary embodiment, the processor 110 performs these functions by executing one or more of the above-referenced programs 113 stored in the memory 112.

In executing these steps, the processor 110 preferably also utilizes a database 115 that is also stored in the memory 112. The database 115 preferably includes various information regarding the vehicle occupants (such as financial records, demographic information, an identification of the occupant's user wireless device 132, a history of locations visited by the occupants, preferences and/or ratings of the occupants as to various points of interest (such as restaurants, service stations, hotels, attractions, and other points of interest) and information pertaining thereto (such as a vehicle history with respect to such points of interest and/or ratings and/or other preferences from the occupants of the vehicle and/or from others pertaining to the points of interest). In certain embodiments, the database 115 could also be off-board the vehicle (for example as part of the database 142 of the remote server 130) and accessed via the transmitter 103 and the receiver 102.

The memory 112 can be any type of suitable memory. This would include the various types of dynamic random access memory (DRAM) such as SDRAM, the various types of static RAM (SRAM), and the various types of non-volatile memory (PROM, EPROM, and flash). In certain embodiments, the memory 112 is located on and/or co-located on the same computer chip as the processor 110. It should be understood that the memory 112 may be a single type of memory component, or it may be composed of many different types of memory components. In addition, the memory 112 and the processor 110 may be distributed across several different computers that collectively comprise the computer system 106. For example, a portion of the memory 112 may reside on a computer within a particular apparatus or process, and another portion may reside on a remote computer off-board and away from the vehicle, for example as part of the remote server 130.

The computer bus 114 serves to transmit programs, data, status and other information or signals between the various components of the computer system 106. The computer bus 114 can be any suitable physical or logical means of connecting computer systems and components. This includes, but is not limited to, direct hard-wired connections, fiber optics, infrared and wireless bus technologies.

The interface 116 allows communication to the computer system 106, for example from a vehicle occupant, a system operator, a remote, off-board database or processor, and/or another computer system, and can be implemented using any suitable method and apparatus. In certain embodiments, the interface 116 receives input from an occupant of the vehicle, preferably via the input device 104 of FIG. 1.

The storage device 118 can be any suitable type of storage apparatus, including direct access storage devices such as hard disk drives, flash systems, floppy disk drives and optical disk drives. In one exemplary embodiment, the storage device 118 comprises a program product from which the memory 112 can receive a program 113 that executes the process 200 of FIG. 2 and/or steps thereof as described in greater detail further below. Such a program product can be implemented as part of, inserted into, or otherwise coupled to the navigation system 100. In another exemplary embodiment, the program product may be directly stored in and/or otherwise accessed by the memory 112 and/or a disk (e.g., disk 120), such as that referenced below.

As shown in FIG. 1, the storage device 118 can comprise a disk drive device that uses disks 120 to store data. As one exemplary implementation, the computer system 106 may also utilize an off-board /off-vehicle Internet website, for example for providing or maintaining data or performing operations thereon.

It will be appreciated that while this exemplary embodiment is described in the context of a fully functioning computer system, those skilled in the art will recognize that certain mechanisms of the present disclosure may be capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 110 and/or the processor 140) to perform and execute the program. Such a program product may take a variety of forms, and that the present disclosure applies equally regardless of the particular type of computer-readable signal bearing media used to carry out the distribution. Examples of signal bearing media include: recordable media such as floppy disks, hard drives, memory cards and optical disks (e.g., disk 120), and transmission media such as digital and analog communication links. It will similarly be appreciated that the computer system 106 may also otherwise differ from the embodiment depicted in FIG. 1, for example in that the computer system 106 may be coupled to or may otherwise utilize one or more remote, off-board computer systems and/or other navigation systems, for example as part of the remote server 130. As used throughout this application, a remote computer system refers to a computer system that is off-board and outside the vehicle. For example, a remote computer system may be at a central processing facility for use with a number of different vehicles, among other possible examples.

The display and notification unit 108 is coupled to the computer system 106. In a preferred embodiment, the display and notification unit 108 comprises a visual component 122 (preferably a display screen, such as a liquid crystal display (LCD) screen) that generates images that are visible to occupants of the vehicle, and an audio component 124 (such as a speaker) that generates sounds that can be heard by the occupants of the vehicle. It will be appreciated that the display and notification unit 108 may comprise one or more visual components 122 and/or audio components 124 together as one system and/or as separate systems.

In one embodiment, the display and notification unit 108 provides marketing material (such as advertisements, menus, coupons, and/or other marketing material) to the occupants of the vehicle. The display and notification unit 108 also provides an optimized display and notification regarding various points of interest near the vehicle based on user history, preferences, and financial and demographic information pertaining to one or more occupants (e.g., the driver) of the vehicle. The visual component 122 preferably displays a list of various points of interest near the vehicle that is prioritized based on a user history and/or other preferences of the user and/or of others, along with information (for example, an address, telephone number, rankings, and/or other information) pertaining to the points of interest. In certain embodiments, the visual component also provides visual information regarding a recommended route to a destination and/or other visual information pertaining to the occupant, the vehicle, and/or the destination.

In certain embodiments, the audio component 124 may also provide audio marketing material (such as an audio advertisement for a nearby point of interest), an audio identification of nearby points of interest audio recommendations regarding recommended routes to a destination, and/or other audio information. In certain embodiments, an audio notification may be provided by the audio component 124 without a video notification being provided by the video component 122, or vice versa.

In certain embodiments, various functions of the navigation system 100 may be performed by the remote server 130. The remote server 130 includes a processor 140, a memory 141, a database 142 stored within the memory 141, a transmitter 144, and a receiver 146. In certain embodiments, the remote processor 140, memory 141, database 142, transmitter 144, and receiver 146 of the remote server 130, are similar to, and may perform some or all of the respective functions of (or functions similar to) the processor 110, memory 112, database 115, transmitter 103, and receiver 102, respectively, of the navigation system 100. Also in certain embodiments, the remote server 130 (or components thereof) and the navigation system 100 (or components thereof) may together form a single system.

The remote server 130 is coupled to the receiver 102 and transmitter 130 of the navigation system 100 via wireless connection 135 (for example, a cellular network or other wireless network). The remote server 130 is coupled to the user wireless device 132 via wireless connection 136 (for example, a cellular network or other wireless network). In one embodiment, wireless connections 135, 136 comprise different wireless connections. In another embodiment, wireless connections 135, 136 comprise one or more common or identical wireless connections.

FIG. 2 is a flowchart of a process 200 for providing marketing material and other information to occupants (also referred to herein as users) of a vehicle, in accordance with an exemplary embodiment. In a preferred embodiment, the process 200 can be implemented in connection with the navigation system 100 and the remote server 130 of FIG. 1.

As depicted in FIG. 2, the process 200 includes the step of obtaining user information (step 202). The user information includes information that may be used in identifying a driver and/or other occupants of the vehicle. In one embodiment, the user information includes a signal obtained by the receiver 102 of FIG. 1 from a user wireless device 132 of FIG. 1 of an occupant of the vehicle. In another embodiment, the user information includes an input received by the input device 104 from an occupant of the vehicle identifying the name of the occupant (for example, in which the occupant presses a button corresponding to the occupant's name, selects the occupant's name from a menu, or the like). In another embodiment, the user information includes information obtained by one or more other vehicle systems 109 of FIG. 1 (for example, a steering system, a braking system, or the like) pertaining to how the vehicle is being operated (for example, as to where the vehicle is traveling, how fast the vehicle is being driven, how often the driver is applying the brakes and/or how much force is applied to the brake pedal, how often the driver is applying the accelerator pedal and/or how much force is applied to the accelerator pedal, how often the driver is engaging the steering wheel and/or how much torque is applied to the steering wheel, and the like). The user information is preferably provided to the processor 110 and/or the processor 140 of FIG. 1 for processing.

An identification of one or more occupants of the vehicle is then made (step 204). The identification of step 204 preferably comprises an identification of a driver of the vehicle. The identification of step 204 may also include an identification of one or more other occupants of the vehicle, instead of or in addition to the driver. The identification of step 204 is preferably performed by the processor 110 and/or the processor 140 of FIG. 1 based on the user information obtained in step 202.

In one embodiment, the occupant is identified during step 204 by comparing the signal obtained by the receiver 102 of FIG. 1 from the user wireless device 132 of FIG. 1 with stored information from the database 115 and/or the database 142 of FIG. 1 pertaining to user wireless devices 132 of various possible occupants of the vehicle. In one such embodiment, the driver is identified by a vehicle key FOB via one of the other vehicle systems 109. The driver may also be identified via a unique short-range wireless address of the driver's cellular telephone. Alternatively, the occupant may be identified during step 204 by evaluating the information as to how the vehicle is being operated and comparing the results with stored information regarding driving patterns from various possible occupants of the vehicle stored in the database 115 and/or the database 142 of FIG. 1. For example, if the driver is taking a similar route to one previously taken by the driver (for example, at a similar time of day), then this may be utilized to identify and provide marketing materials to the driver with relevance to that particular route of travel. The occupant may also be identified during step 204 using self identification by the occupant via the input device 104 of FIG. 1 during step 202.

In addition, a user history is obtained (step 206). The user history preferably includes information pertaining to various points of interest that an occupant of the vehicle has visited (for example, as determined by the navigation system 100 based on prior operation of the vehicle and stored in the database 115 of FIG. 1) and preferences of the occupant as to marketing information in which the occupant may be interested (for example, as selected by the occupant on the user computer 134 before the user enters the vehicle and subsequently received by the receiver 102 of FIG. 1 via a wireless connection and stored in the database 115 of FIG. 1). The user history may also include user preferences regarding points of interest (for example, as to the occupant's favorite types of restaurants, shopping centers, hotels, and the like, which may be similarly collected from the user computer 134 of FIG. 1 by the receiver 102 of FIG. 1 via a wireless connection and stored in the database 115 of FIG. 1). In addition, the user history may include financial information pertaining to the occupant, such as the occupant's credit card history and records of financial transactions for the occupant. The user history may also include demographic information pertaining to the occupant, such as the occupant's age, gender, education level, income, and the like. The user history is preferably retrieved by the processor 110 and/or the processor 140 of FIG. 1 from the database 115 and/or the database 142 of FIG. 1. The user information may also include billing information from utilities (such as telephone, electric, natural gas, and/or cable television and/or Internet providers), mortgage payments, payments to online and/or other merchants, and vehicle payments, for example that may be retrieved from ban account information and/or other transaction history with the user's permission.

In addition, a vehicle location is determined (step 208). In a preferred embodiment, the vehicle location comprises a geographic position of the vehicle, and is determined continuously during operation of the vehicle. The vehicle location and/or information pertaining thereto is preferably obtained by the receiver 102 of FIG. 1, most preferably via satellite signals provided by one or more satellites coupled thereto as part of a global positioning system. In certain embodiments, the receiver 102 of FIG. 1 may receive the vehicle location and/or information pertaining thereto from another source, such as from a remote, off-board processor or system. Also in a preferred embodiment, the receiver 102 provides a signal indicative of the vehicle location to the processor 110 of the computer system 106 of FIG. 1 for processing.

In certain embodiments, a current time of day and day of the week are also determined (step 210). Preferably the current time of day and day of the week are determined by the processor 110 of FIG. 1.

Various points of interest are identified that are near the vehicle (step 212). The points of interest are preferably identified by the processor 110 of FIG. 1 from a collection of points of interest stored in the database 115 of FIG. 1 continuously during operation of the vehicle. In certain embodiments, the collection of points of interest may instead be stored in a remote, off-board database, and/or the identification may be performed by a remote, off-board processor. The points of interest may be identified based at least in part upon a user input provided by one or more occupants of the vehicle, for example as to the type of point of interest that the occupants may be interested in visiting during the current ignition cycle or vehicle ride, the preferences expressed by the occupant on the user computer 134 of FIG. 1, and/or the financial records, demographic information, and/or other user history from step 206.

In addition, distances of the various nearby points of interest are calculated (step 214). In one exemplary embodiment, the distance for each point of interest comprises a current distance between the point of interest and the vehicle. In certain embodiments, other factors may also be considered, such as a direction in which the vehicle is currently traveling, a road on which the vehicle is currently travelling, and the like. The distances for the various points of interest are preferably calculated by the processor 110 of FIG. 1 continuously during operation of the vehicle.

Measures of relevancy of the various nearby points of interest are then retrieved or determined (step 216). Preferably the measures of relevancy are determined in step 216 using the user history of step 206, including the points of interest previously visited by one or more occupants of the vehicle, the preferences expressed by the occupants on the user computer 134 of FIG. 1, the financial records of the occupants, and the demographic information pertaining to the occupant. The user history is preferably retrieved from the database 115 and/or the database 142 of FIG. 1 by the processor 110 and/or the processor 140 of FIG. 1 for making the relevancy determinations of step 216.

Preferably, the processor 110 and/or the processor 140 of FIG. 1 calculate a relevancy score for each of the nearby points of interest during step 216 using the user history of step 206 and the distances of step 214. Specifically, the points of interest are provided with relatively higher relevancy scores the more compatible the points of interest are with the user history. The points of interest are also provided with relatively higher relevancy scores the shorter the distance is between the point of interest and the vehicle and/or to a path of the vehicle.

The relevancy scores of step 216 may also be calculated using the current time of day and/or day of the week as determined in step 210. For example, if the user is looking for a restaurant and the time of day is early morning, a higher relevancy score may be provided to a restaurant that is known for breakfast service, and/or that the user has frequented often during the early mornings. By way of further example, if the day of the week is a weekend day, then a higher relevancy score may be provided to a restaurant that is known for weekend service, and/or that the user has frequented often during the weekends.

In one embodiment, for points of interest that are part of generic groups (such as different locations of a restaurant chain), the popularity or relevancy scores for such points of interest are aggregated for the group in order to compare group popularity (for example, for all of the different locations of the restaurant chain). This aggregation process can take place through several levels of a predetermined hierarchy. For example, different fast food restaurants and/or fast food restaurant chains may also be aggregated into a fast food category to generate a fast food popularity or relevancy measure. By way of further example, fast food restaurants and/or fast food restaurant chains may also be aggregated with other family style restaurants and/or family style restaurant chains to generate a family dining popularity or relevancy measure, and so on.

The relevancy scores are preferably calculated by the processor 110 of FIG. 1 continuously during operation of the vehicle. Preferably the processor 110 of FIG. 1 calculates relevancy scores for the n closest points of interest identified in step 212, such that at least n points of interest with a popularity score greater than zero are included, wherein n represents the number of points of interest presented on a first page of the display and notification unit 108 of FIG. 1.

The nearby points of interest are then sorted and displayed in accordance with their relevancy scores (step 218). Preferably, the points of interest are sorted (or prioritized) and provided in descending order with the highest relevancy scores listed first. For example, while traditional navigation systems present points of interest in ascending distance from the present vehicle position, the sorted or “best guess” results of the process 200 are displayed based on the calculated relevancy scores, which take into account the point of interest popularity counter (the higher the counter, the higher the relevancy score) and its distance from the present location of the vehicle (the farther away, the lower the relevancy score). This sorting can save the user time and effort by minimizing the time it takes to view the points of interest that are likely to be of the most interest to the user. In addition, this sorting also provides the user with the opportunity to view the most relevant points of interest without scrolling through the navigation display or with reduced scrolling. In certain vehicles in which scrolling through the navigation display is not permitted while the vehicle is moving, this sorting may enable the user to view various relevant points of interest that the user might not otherwise have been able view while the vehicle is moving.

During step 218, the sorted (or prioritized) list of nearby points of interest is displayed for the user by the display and notification unit 108 of FIG. 1. The sorted (or prioritized) list is preferably displayed for the user by the visual component 122 (for example a display screen, such as liquid crystal display (LCD) screen) of the display and notification unit 108 of FIG. 1 based on instructions provided thereto by the processor 110 of FIG. 1 continuously while the vehicle is being operated. In addition, during step 218, preferably the above-referenced n points of interest are displayed in descending order of their relevancy scores. Ideally the driver will find his or her destination among the few n points of interest presented on the first page, but can also access the traditional list of points of interest by distance in a subsequent screen if desired.

In addition, marketing material is indentified (step 220). Specifically, applicable marketing material is identified that is tailored to the particular occupants of the vehicle based on the user history of step 206, the vehicle location of step 208, and the distances of step 214. The marketing material is preferably identified using the processor 110 and/or the processor 140 of FIG. 1 using the user history.

In one embodiment, a history of points of interest of which the occupant has visited is utilized in identifying marketing material for the occupant. For example, if the occupant is known to frequent one particular type of restaurant (such as fast food), then the marketing material may pertain to a fast food restaurant, and the like, that is relatively close in proximity (e.g., that has a relatively short distance) to the vehicle and/or a path and/route of the vehicle. The marketing material may also pertain to a particular brand or name of a point of interest that the occupant is known to visit and that is in proximity to the vehicle. In yet other embodiments, the marketing material may pertain to a competitor of a particular brand or name of a point of interest that the occupant is known to visit (such as a competing brand of fast food restaurants other than the fast food restaurant with which the consumer has been known to visit, and the like) and that is in proximity to the vehicle.

In another embodiment, the financial records (such as credit card records, transaction history, and the like) are utilized in identifying marketing material for the occupant. For example, if the financial records reveal transactions of the occupant pertaining to one particular type of restaurant (such as fast food), then the marketing material may pertain to a fast food restaurant that is in proximity to the vehicle. The marketing material may also pertain to a particular brand or name of a point of interest pertaining to the financial records, such as a particular brand of fast food restaurants with which the consumer has a record of financial transactions, and the like. In yet other embodiments, the marketing material may pertain to a competitor of a particular brand or name of a point of interest pertaining to the financial records, such as a competing brand of fast food restaurants other than the fast food restaurant with which the consumer has a record of financial transactions, and the like. Financial records could also provide information as to which restaurants, stores, and/or other points of interest frequented by the consumer, and coupons and/or other marketing information and/or materials can then be provided to the consumer for such places of interest that are in line with or in proximity to a travel route being taken by the consumer, a direction in which the consumer is headed, a particular time of day in which the consumer is likely to utilize such a place of interest, and the like. In one example, the consumer's proximity to such places of interest may be a calibratable value (such as when the consumer is within a one mile radius, a five mile radius, or the like location, or when the consumer is within a further distance threshold if the place of interest is within or close to a predicted route of the consumer, and the like).

In yet another embodiment, the demographic information (such as the gender, age, education level, and income of the occupant) is utilized in identifying marketing material for the occupant. For example, if the occupant belongs to a demographic group that is believed to have a significant percentage of its members that frequent one particular type of restaurant (such as fast food), then the marketing material may pertain to a fast food restaurant (and/or to a particular type of hotel, retail store, and/or one or more other types points of interest). The marketing material may also pertain to a particular brand or name of a point of interest that may be associated with the group (such as a particular type of restaurant, hotel, retail store, or the like that may cater to a particular age bracket in which the occupant is a member, by way of example). By way of example, such demographic information may be obtained via financial records, public records pertaining to the consumer and/or groups to which the consumer belongs, and/or other identifying information pertaining to the consumer. In yet other embodiments, the marketing material may pertain to a competitor of a particular brand or name of a point of interest associated with the group. In still other embodiments, various combinations of the history of points of interest, the financial records, the demographic information, and/or other user history may be used in combination to further tailor the marketing material for the specific occupants of the vehicle.

Marketing material is provided for the occupant (step 222). The marketing material provided in step 222 preferably comprises the marketing material identified in step 220. The marketing material is preferably provided to the occupant via one or more delivery units (such as the transmitter 103 of FIG. 1, the transmitter 144 of FIG. 1, and/or the display and notification unit 108 of FIG. 1, for example as described below). In one embodiment, the marketing material is transmitted to the user wireless device 132 by the transmitter 103 of the navigation system 100 of FIG. 1 via the wireless connection 137 of FIG. 1 based on instructions provided by one or more of the processors 110, 140 of FIG. 1. In another embodiment, the marketing material is transmitted to the user wireless device 132 by the transmitter 144 of the remote server 130 of FIG. 1 via the wireless network 136 of FIG. 1 based on instructions provided by one or more of the processors 110, 140 of FIG. 1. In yet another embodiment, the marketing material is displayed via the display and notification unit 108 of FIG. 1 (preferably by the visual component 122 thereof) based on instructions provided by one or more of the processors 110, 140 of FIG. 1.

In addition, in certain embodiments, a calendar of the occupant is accessed (step 224). The calendar is preferably accessed by the processor 110 and/or the processor 140 of FIG. 1. In one embodiment, the calendar is stored within the memory 112 of the computer system 106 of FIG. 1 of the navigation system 100 of FIG. 1, and is directly accessed by the processor 110 of FIG. 1 from the memory 112. In another embodiment, the calendar is stored in another memory of one or more other vehicle systems 109 of FIG. 1, and is accessed by the processor 110 therefrom via a communications bus of the vehicle. In yet another embodiment, the calendar is stored in the memory 141 of the remote server 130 of FIG. 1, and is accessed by the processor 140 of FIG. 1. In still other embodiments, the calendar is stored at one or more other locations (such as on a third party website), and is accessed by one of the processors 110, 140 of FIG. 1 via one or more of the respective receivers 102, 146 of FIG. 1.

A determination is then made as to a desired route for a destination in which the vehicle is travelling (step 226). The destination may be obtained by the occupant's selection of a point of interest from the input device 104 of FIG. 1. Alternatively, the destination may be obtained by a prior selection of the occupant on the user computer 134 of FIG. 1 before the occupant entered the vehicle. The destination may also be obtained from the calendar itself. In either case, during step 226, one of the processors 110, 140 of FIG. 1 preferably determines a desired time for the occupant to reach the destination based on an appointment time corresponding to that destination in the calendar.

Also during step 226, one of the processors 110, 140 of FIG. 1 determines a preferred route to reach the destination utilizing the desired time, preferably along with the vehicle location of step 208 as well as one or more additional factors (such as traffic conditions on roads of various possible routes, an estimated amount of time required to reach the destination using the various possible routes, an estimated amount of fuel and/or carbon emissions required to reach the destination using the various possible routes, and the like). For example, if the occupant is running late for an appointment at a destination, then one of the processors 110, 140 may recommend a route with a relatively shorter expected travel time (for example, a road with a relatively higher speed limit, or a more direct route). Conversely, and by way of further example, if the occupant has ample time to reach the destination in time for the appointment, then one or more of the processors 110, 140 of FIG. 1 may recommend a more leisurely and/or environmentally friendly route (e.g., a road with fewer stop lights). Various different algorithms may be utilized for determining such desirable routes, for example using posted speed limits, road types, number of stop lights, number of stop signs, terrain, and/or traffic patterns associated with various possible routes of travel.

Information regarding a preferred route to a destination of the vehicle is provided for the occupant (step 228). The preferred route information preferably corresponds to the preferred route identified in step 226. In one embodiment, the preferred route information is displayed via the display and notification unit 108 of FIG. 1 (for example, by the visual component 122 and/or the audio component 124 thereof) based on instructions provided by one or more of the processors 110, 140 of FIG. 1.

It will be appreciated that the disclosed systems and processes may differ from those depicted in the Figures and/or described above. For example, the navigation system 100 and/or various parts and/or components thereof may differ from those of FIG. 1 and/or described above. Similarly, certain steps of the process 200 may be unnecessary and/or may vary from those depicted in FIG. 2 and described above. It will similarly be appreciated that various steps of the process 200 may occur simultaneously or in an order that is otherwise different from that depicted in FIG. 2 and/or described above. It will similarly be appreciated that, while the disclosed methods and systems are described above as being used in connection with automobiles such as sedans, trucks, vans, and sports utility vehicles, the disclosed methods and systems may also be used in connection with any number of different types of vehicles, and in connection with any number of different systems thereof and environments pertaining thereto.

Accordingly, methods and systems are disclosed for providing marketing material and other information to occupants of vehicles via vehicle navigation systems. The disclosed methods and systems provide targeted marketing material to vehicle occupants regarding various points of interest near the vehicle based on an identification of one or more of the occupants. In addition, the disclosed methods and systems provide recommended routes to the occupants for reaching a destination, among other information, using a calendar of one or more of the occupants.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for marketing to an occupant of a vehicle, the method comprising the steps of:
identifying the occupant;
accessing information pertaining to the occupant from a database; and
providing marketing material to the occupant based on the information using a processsor.

2. The method of claim 1, wherein the step of identifying the occupant comprises the steps of:
obtaining an input from the occupant via a user interface; and
identifying the occupant using the input.

3. The method of claim 1, wherein the step of identifying the occupant comprises the steps of:
receiving a signal from a wireless device; and
identifying the occupant using the signal.

4. The method of claim 1, wherein the step of identifying the occupant comprises the steps of:
performing an evaluation of a manner in which the vehicle is being driven; and
identifying the occupant using the evaluation.

5. The method of claim 1, wherein:
the step of accessing the information comprises the step of accessing a history of businesses which the occupant has visited; and
the step of providing the marketing material comprises the step of providing the marketing material to the occupant based on the history.

6. The method of claim 5, further comprising the step of:
identifying a competitor of one of the businesses;
wherein the step of providing the marketing material comprises the step of providing the marketing material to the occupant regarding the competitor.

7. The method of claim 1, wherein:
the step of accessing the information comprises the step of accessing financial records pertaining to the occupant; and
the step of providing the marketing material comprises the step of providing the marketing material to the occupant based on the financial records.

8. The method of claim 1, wherein:
the step of accessing the information comprises the step of accessing demographic information pertaining to the occupant; and
the step of providing the marketing material comprises the step of providing the marketing material to the occupant based on the demographic information.

9. The method of claim 1, wherein the step of providing the marketing material comprises the step of providing the marketing material to the occupant via a display device of a navigation system of the vehicle.

10. The method of claim 1, wherein the step of providing the marketing material comprises the step of transmitting the marketing material to a wireless device of the occupant.

11. A method of notifying an occupant of a vehicle travelling toward a destination, the method comprising the steps of:
accessing a calendar of the occupant;
determining a desired time to reach the destination using the calendar; and
providing a notification regarding a desired route for the vehicle based on the desired time.

12. The method of claim 11, further comprising the step of:
determining a location of the vehicle, wherein the step of providing the notification comprises the step of providing the notification regarding the desired route for the vehicle based on the desired time and the location.

13. The method of claim 11, wherein:
the calendar resides on a navigation system of the vehicle; and
the step of accessing the calendar comprises the step of accessing the calendar from the navigation system.

14. The method of claim 11, wherein:
the calendar resides on a remote server; and
the step of accessing the calendar comprises the step of accessing the calendar from the remote server.

15. A system for marketing to an occupant of a vehicle, the system comprising:
a processor configured to:
identify the occupant;
access information pertaining to the occupant from a database; and
provide instructions for delivery of marketing material to the occupant based on the information; and
a delivery unit coupled to the processor and configured to deliver the marketing material to the occupant based on the instructions.

16. The system of claim 15, wherein the delivery unit is configured to transmit the marketing material to a wireless device of the occupant.

17. The system of claim 15, wherein the delivery unit is configured to provide the marketing material to the occupant via a display device of a navigation system of the vehicle.

18. The system of claim 15, further comprising:
a receiver configured to receive a signal from a wireless device of the occupant, wherein the processor is configured to identify the occupant using the signal.

19. The system of claim 15, wherein the processor is configured to:
perform an evaluation of a manner in which the vehicle is being driven; and
identify the occupant using the evaluation.

20. The system of claim 15, wherein the processor is further configured to:
access financial records pertaining to the occupant; and
provide the marketing material to the occupant based on the financial records.
